(19) United States
(12) Patent Application Publication
(10) Pub. No.: US 2023/0302503 A1
(43) Pub. Date: Sep. 28, 2023

(54) APPARATUS FOR THE AUTOMATIC REFRESHING OF AN ADHESIVE ROLL

(71) Applicant: Illinois Tool Works Inc., Glenview, IL (US)

(72) Inventors: Sheila Hamilton, Glasgow (GB); Stephen Frank Mitchell, Glasgow (GB)

(21) Appl. No.: 18/019,374

(22) PCT Filed: Aug. 5, 2021
(86) PCT No.: PCT/US2021/044604

§ 371 Date: Feb. 2, 2023

(30) Foreign Application Priority Data
Aug. 7, 2020 (GB) 2012316.2
Jul. 19, 2021 (GB) 2110347.8

(51) Int. Cl. B08B 7/00; B08B 1/00

(52) U.S. Cl. CPC B08B 7/0028; B08B 1/007

(57) ABSTRACT

Apparatus (10) for automatically removing an exhausted layer of adhesive material from an adhesive roll (12), said apparatus comprising an adhesive roll (12) comprising at least one layer of adhesive material (22), said at least one adhesive layer having first and second mutually opposing faces, said second face releasably attached to said adhesive roll and having a first adhesion force between said second face and an said adhesive roll; and an adhesive layer removal mechanism (14) comprising an outer surface arranged to operably engage said at least one layer of adhesive material of said adhesive roll and remove the same from said adhesive roll, said outer surface having a second adhesion force between said outer surface and said at least one layer of adhesive material, wherein said second adhesion force is greater than the first adhesion force.

### TECHNICAL FIELD OF INVENTION

The invention relates to an apparatus for the automatic refreshing, or replenishment, of an adhesive roll. The invention also relates to a method of use thereof. More specifically, the invention relates to a contact cleaning apparatus for the automatic refreshing, or replenishment, of an adhesive roll.

### SUMMARY OF INVENTION

In accordance with one aspect of the invention, there is provided an apparatus for automatically removing an exhausted layer of adhesive material from an adhesive roll, comprising:
an adhesive roll comprising at least one layer of adhesive material having first and second mutually opposing faces, said second face releasably attached to said adhesive roll and having a first adhesion force between said second face and said adhesive roll; and
an adhesive layer removal mechanism comprising an outer surface arranged to operably engage said at least one layer of adhesive material of said adhesive roll and remove the same from said adhesive roll, said outer surface having a second adhesion force between said outer surface and said at least one layer of adhesive material,
wherein said second adhesion force is greater than the first adhesion force.

The first adhesion force may be present between said second face and a mandrel, or central core, of said adhesive roll. Alternatively, or additionally, the first adhesion force may be present between said second face of one layer, or portion, of adhesive material, and a first face of another layer, or portion, of adhesive material.

The second adhesion force may be present between said outer surface of said adhesive layer removal mechanism and said at least one layer of adhesive material (i.e. said operably engaged sheet(s) of adhesive material).

In this way, the adhesive layer removal mechanism is arranged to contact the outermost layer of adhesive material of the adhesive roll and remove the same from the adhesive roll, thereby exposing a clean or fresh (i.e. having no debris or the like) layer of adhesive material on the adhesive roll.

This provides the advantage that an adhesive roll in a contact cleaning apparatus is automatically replenished during operation. Thus, equipment downtime is reduced, operator intervention is reduced, and the system is allowed to perform at full capacity/performance.

In certain embodiments, the adhesive roll is configured for use in a contact cleaning apparatus. More specifically, the adhesive roll comprises a roll core mountable in a contact cleaning apparatus. Yet more specifically, the roll core is a central core, or mandrel.

In certain embodiments, the first face of the at least one layer of adhesive material is configured to contact a cleaning roller when the adhesive roll is mounted in a contact cleaning apparatus comprising at least one cleaning roller and an adhesive roll as described herein.

In certain embodiments the adhesive layer removal mechanism comprises a pick up device operable to engage with the adhesive layer and to remove the adhesive layer from the adhesive roll.

In certain embodiments the pick up device is a pick up roller. More specifically, the pick up roller may be an elastomeric roller.

In one embodiment, said adhesive layer removal mechanism is configured to be moveable between a first configuration, in which said adhesive layer removal mechanism operably engages said adhesive roll, and a second configuration, in which said adhesive layer removal mechanism is disengaged from said adhesive roll.

In certain embodiments, the pick up device is movable from a stowed position, in which it is not engaged with the at least one layer of adhesive layer of the adhesive roll, and an operable position, in which the pick up device is engaged with said adhesive layer.

In one embodiment, the apparatus further comprises a waste removal mechanism arranged to operably engage said at least one layer of adhesive material on said adhesive layer removal mechanism and remove the same from said adhesive layer removal mechanism.

In certain embodiments, said waste removal mechanism comprises a tangential blade configured and arranged to remove the adhesive layer from the pick up device of the adhesive layer removal mechanism.

In certain embodiments, the waste removal mechanism comprises a rewind roller. In this way, the removed adhesive layer (e.g. adhesive sheet) may be wound around the rewind roller, which can be disposed of and replaced when full.

In certain embodiments, the at least one layer of adhesive material comprises at least one sheet of adhesive material. In such cases, the adhesive layer removal mechanism is an adhesive sheet removal mechanism.

In certain embodiments, said at least one layer of adhesive material comprises a continuous adhesive sheet.

In certain embodiments, said at least one layer of adhesive material comprises a plurality of adhesive sheets operably coupled to one another at adjoining ends thereof.

In accordance with another aspect of the invention, there is provided a method comprising the steps of:
providing an adhesive roll as described herein;
providing an adhesive layer removal mechanism as described herein;
operably engaging said adhesive layer removal mechanism with said at least one layer of adhesive material of said adhesive roll; and
removing, by said adhesive layer removal mechanism, said operably engaged at least one layer of adhesive material from said adhesive roll, thereby exposing a clean layer of adhesive material on said adhesive roll.

In one embodiment, the method further comprises the step of providing a waste removal mechanism and the step of removing, by said waste removal mechanism, said operably engaged at least one layer of adhesive material from said adhesive layer removal mechanism.

In one embodiment, the method comprises the steps of
providing a contact cleaning apparatus comprising one or more contact cleaning rollers
operably engaging said at least one layer of adhesive material of said adhesive roll with said one or more contact cleaning rollers so as to remove debris therefrom.

In accordance with another aspect of the invention, there is provided a contact cleaning apparatus comprising one or more contact cleaning rollers, one or more adhesive rolls configured and arranged to remove debris from the one or more contact cleaning rollers and the apparatus for automatically removing an exhausted layer of adhesive material from the adhesive roll(s), as described herein.

### BRIEF DESCRIPTION OF DRAWINGS

Example embodiment(s) of the invention are illustrated in the accompanying drawings, in which:

FIG. 1 illustrates a side view of an apparatus according to the invention in one configuration;

FIG. 2 illustrates a side view of the apparatus of FIG. 1 in another configuration;

FIG. 3 illustrates a side view of the apparatus of FIG. 1 in a further configuration;

FIG. 4 illustrates a side view of the apparatus of FIG. 1 in yet a further configuration; and

FIG. 5 illustrates a perspective view of the apparatus of FIG. 1.

### DETAILED DESCRIPTION

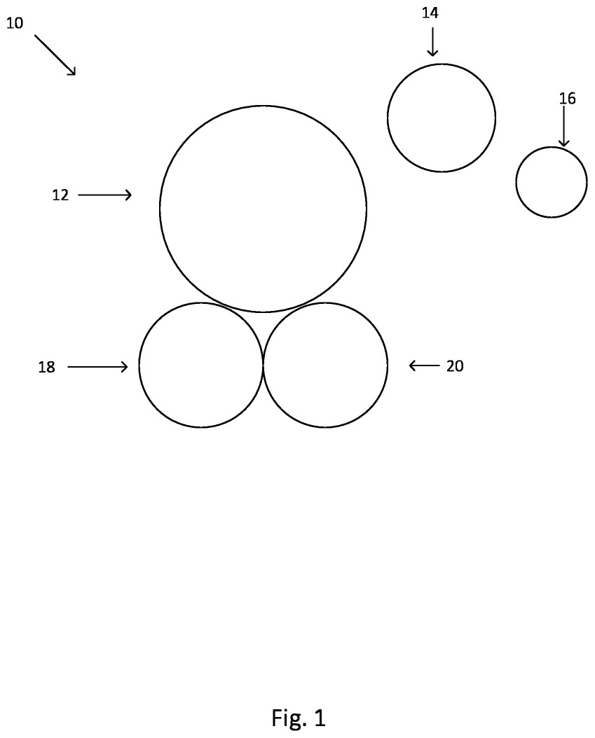

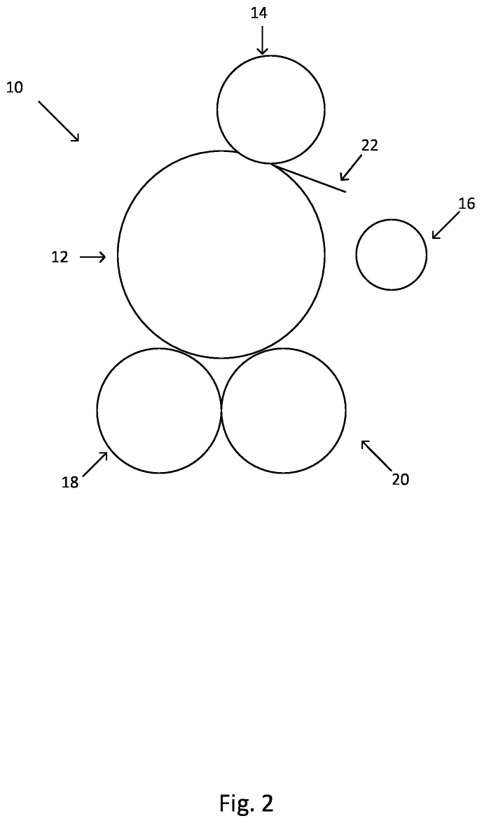

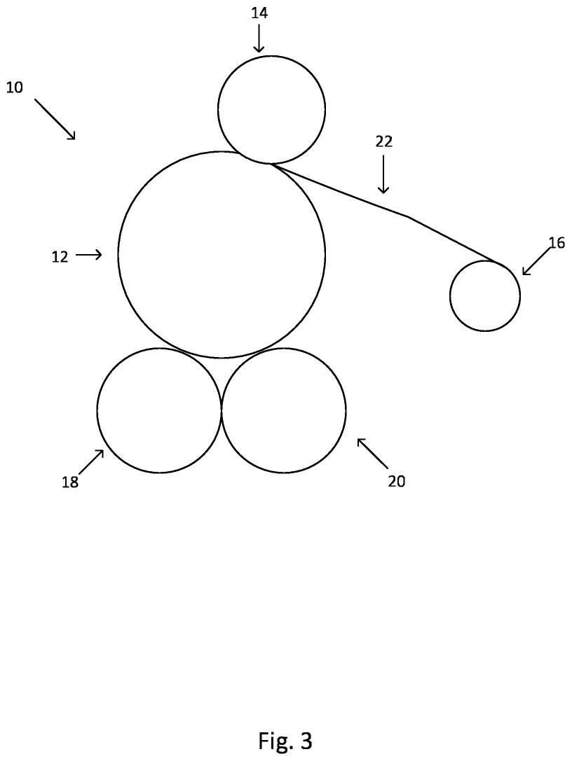

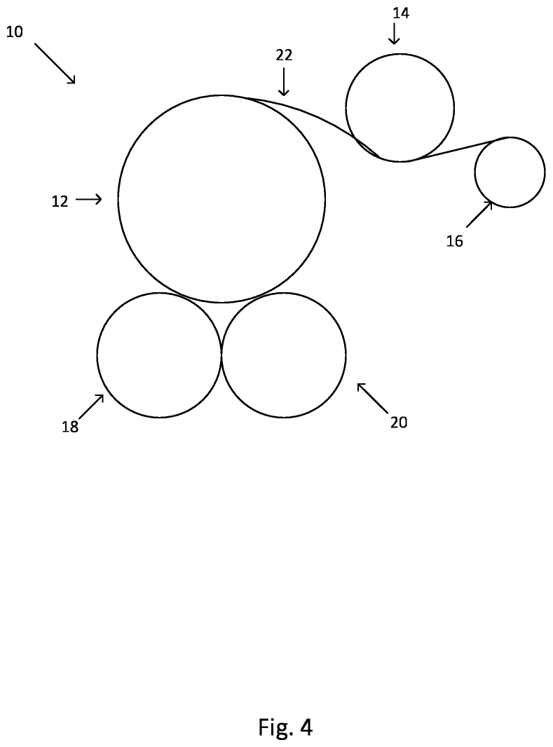

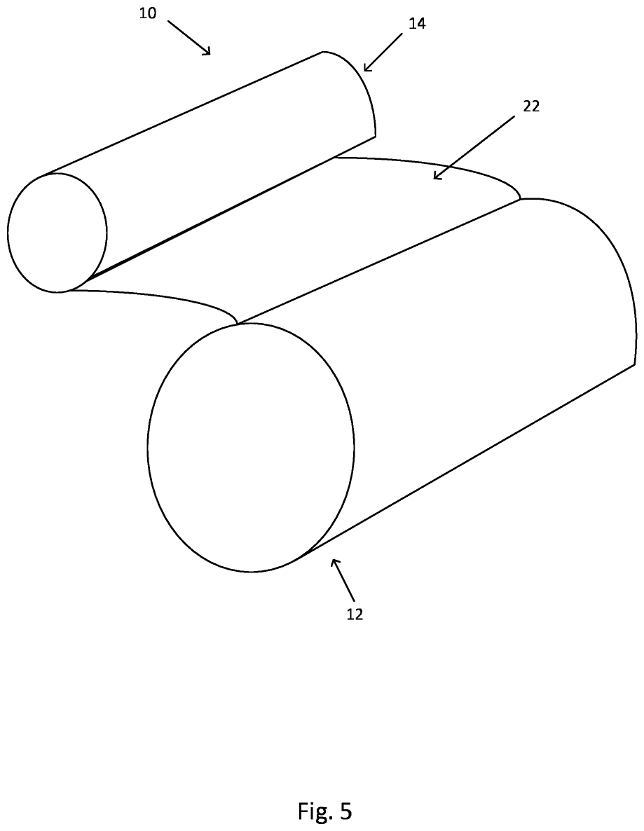

FIGS. 1 to 5, particularly FIGS. 1 and 5, illustrate an apparatus 10 including an adhesive roll 12, an adhesive sheet removal mechanism 14 and a rewind roller 16. There is also shown contact cleaning rollers 18, 20, which are arranged to contact a substrate to be cleaned (not shown), in use. The adhesive roll 12 is arranged to contact the contact cleaning rollers 18, 20. The adhesive sheet removal mechanism 14 is moveable between a first configuration, shown in FIG. 1, in which the adhesive sheet removal mechanism 14 does not contact the adhesive roll 12, and a second configuration, shown in FIG. 2 and described below, in which the adhesive sheet removal mechanism 14 contacts the adhesive roll 12.

The adhesive roll 12 is generally formed with a central core, or mandrel, and one or more sheets of adhesive material 22 (see FIG. 2). The adhesive material 22 may assume the form of several individual sheets attached at adjoining ends or a continuous sheet of adhesive material. The individual sheets and/or continuous sheet of adhesive material 22 may include perforations or frangible portions so as to delimit individual sheets or regions of the continuous sheet of adhesive material. The adhesive roll 12 may include a diameter of 25 mm (1″) to 150 mm (6″) and/or a roll length of 10 meters to 40 meters. The adhesive material 22 may be formed as a pre-sheeted adhesive roll, comprising individual sheets wound on the central core or mandrel, typically having 50 to 100 sheets. The adhesive material may be formed as a continuous roll of adhesive material, typically 10 to 50 meters in length.

The one or more sheets of adhesive material 22 generally include first and second mutually opposing faces, one of which, i.e. the first face, is arranged to contact the contact cleaning rollers 18, 20 so as to remove debris therefrom, and the other, i.e. the second face, is arranged to releasably attach the one or more sheets of adhesive material to the central core or mandrel. In embodiments in which a plurality of sheets of adhesive material 22 are provided, or an extended continuous sheet of adhesive material 22, the second face may releasably attach the sheet to the first face of another sheet, or to another portion of the continuous sheet. The first and second faces may be arranged in any appropriate manner so as to provide the functions outlined above. For example, they may comprise appropriate chemical adhesives.

The adhesive sheet removal mechanism 14 may be moveable between a first configuration (FIG. 1), in which the adhesive sheet removal mechanism 14 does not contact the adhesive roll 12, and a second configuration (FIG. 2), in which the adhesive sheet removal mechanism 14 contacts the adhesive roll 12, specifically the sheet of adhesive material 22. The moveable mechanism may be any appropriate mechanism, and may include one or more biasing and/or actuating mechanisms.

The adhesive sheet removal mechanism 14, being a pick up or replenishing device, is generally formed as a roller, including a central core, or mandrel, and an outer surface. The outer surface may include an adhesive material, such as a chemical adhesive. Alternatively, the outer surface may comprise elastomeric material and/or the roller may be an elastomeric roller. The outer surface generally contacts the adhesive roll 12 in the second configuration, as shown in FIG. 2. An adhesive force between the outer surface of the adhesive sheet removal mechanism 14 and the sheet of adhesive material 22 of the adhesive roll 12 is generally greater than an adhesive force between the sheet of adhesive material 22 of the adhesive roll 12 and either the central core or mandrel of the adhesive roll 12, or another one of the sheets of adhesive material 22. As described below, this allows the adhesive sheet removal mechanism 14 to automatically remove exhausted sheets of adhesive material 22 and allow replenishment of the adhesive roll 12 by way of exposing a clean, or fresh, adhesive material 22 of the adhesive roll 12.

The rewind roller 16 is provided as a waste removal mechanism (or a part thereof) for removing the exhausted sheets of adhesive material 22 from the adhesive sheet removal mechanism 14. In this embodiment, the rewind roller 16 removes the exhausted sheets 22 from the adhesive sheet removal mechanism 14 so as to wind said exhausted sheets 22 around the rewind roller 16. The exhausted sheets 22 and/or the rewind roller 16 may then be discarded. In certain embodiments (not shown), a tangential blade is provided as a waste removal mechanism or a part thereof so as to peel exhausted sheets 22 from the adhesive sheet removal mechanism 14, optionally into a waste bin or the like.

As shown in FIGS. 2 to 4, in a first step, the adhesive sheet removal mechanism 14 contacts the adhesive roll 12. In a second step, the adhesive sheet removal mechanism 14 removes an exhausted sheet, or section, of the adhesive sheet(s) 22 of the adhesive roll 12.

In the case of pre-sheeted adhesive rolls, a single sheet is removed, and either the single sheet is provided for disposal (e.g. by way of a tangential blade and, optionally, a waste bin), or stored within the machine (e.g. on rewind roller 16) for disposal at a future time. In the case of a continuous adhesive roll, a length equivalent to at least the outer diameter of the adhesive roll is removed, the adhesive sheet is then cut (e.g. by way of a blade; or by perforating a perforatable or frangible region by virtue of a pulling action of the adhesive sheet removal mechanism 14) thereby creating a sheet of exhausted adhesive and disposed of as outlined above. In a third step, by removing the outer adhesive layer/sheet 22, a clean unused adhesive layer is exposed, and thus the adhesive roll 12 is replenished. In a fourth step, the apparatus 10 returns automatically to maximum cleaning performance. In a further step, the adhesive sheet removal mechanism 14 is disengaged from the adhesive roll 12.

As shown in FIG. 5, the adhesive sheet removal mechanism (e.g. pick up roller) 14 engages with the uppermost adhesive sheet on adhesive roll 12 and removes a used adhesive sheet 22 from the adhesive roll 12 to reveal a clean adhesive sheet on adhesive roll 12.

There are multiple advantages of the abovementioned apparatus and methods, including:
a. improved equipment effectiveness by reducing downtime, in conventional systems the machine and the entire production line is stopped to allow for the adhesive to be manually refreshed;
b. reduced operator intervention; and
c. ensuring veracity of the cleaning process by making sure adhesive is always at enough capacity. Should the adhesive roll not be refreshed often enough the cleaning performance of the system declines.

1-13. (canceled)

14. An apparatus for automatically removing an exhausted layer of adhesive material from an adhesive roll, the apparatus comprising:
an adhesive roll comprising at least one layer of adhesive material, the at least one adhesive layer having first and second mutually opposing faces, the second face releasably attached to the adhesive roll and having a first adhesion force between the second face and an the adhesive roll; and
an adhesive layer removal mechanism comprising an outer surface arranged to operably engage the at least one layer of adhesive material of the adhesive roll and remove the same from the adhesive roll, the outer surface having a second adhesion force between the outer surface and the at least one layer of adhesive material,
wherein the second adhesion force is greater than the first adhesion force.

15. The apparatus according to claim 14, wherein the adhesive layer removal mechanism is configured to be moveable between a first configuration, in which the adhesive layer removal mechanism operably engages the adhesive roll, and a second configuration, in which the adhesive layer removal mechanism is disengaged from the adhesive roll.

16. The apparatus according to claim 14, wherein the adhesive layer removal mechanism comprises a pick up device.

17. The apparatus according to claim 16, wherein the pick up device is a roller.

18. The apparatus according to claim 14, further comprising a waste removal mechanism arranged to operably engage the at least one layer of adhesive material on the adhesive layer removal mechanism and remove the same from the adhesive sheet removal mechanism.

19. The apparatus according to claim 18, wherein the waste removal mechanism comprises one or more of: a rewind roller and a tangential blade.

20. The apparatus according to claim 14, wherein the at least one layer of adhesive material comprises a continuous adhesive sheet.

21. The apparatus according to claim 14, wherein the at least one layer of adhesive material comprises a plurality of adhesive sheets operably coupled to one another at adjoining ends thereof.

22. The apparatus according to claim 14, wherein the first face of at least one layer of adhesive material of the adhesive roll is configured to contact at least one cleaning roller so as to remove debris from the first face.

23. A contact cleaning apparatus comprising one or more contact cleaning rollers, one or more adhesive rolls configured and arranged to remove debris from the one or more contact cleaning rollers and the apparatus according to claim 1 for automatically removing an exhausted layer of adhesive material from the adhesive roll(s).

24. A method for automatically removing an exhausted layer of adhesive material from an adhesive roll, the method comprising:
providing an adhesive roll;
providing an adhesive layer removal mechanism;
operably engaging the adhesive layer removal mechanism with the at least one layer of adhesive material of the adhesive roll; and
removing, by the adhesive layer removal mechanism, the operably engaged at least one layer of adhesive material from the adhesive roll, thereby exposing a clean layer of adhesive material on the adhesive roll.

25. The method according to claim 24, wherein the method further comprises the step of providing a waste removal mechanism and the step of removing, by the waste removal mechanism, the operably engaged at least one layer of adhesive material from the adhesive layer removal mechanism.

26. The method according to claim 24, wherein the method further comprises:
providing a contact cleaning apparatus comprising one or more contact cleaning rollers; and
operably engaging the at least one layer of adhesive material of the adhesive roll with the one or more contact cleaning rollers so as to remove debris therefrom.
